(19) United States
(12) Patent Application Publication
(10) Pub. No.: US 2011/0043329 A1
(43) Pub. Date: Feb. 24, 2011

(54) SYSTEM AND METHOD FOR COMPLETING SECURE TRANSACTIONS

(76) Inventors: Conrad R. Carney, II, Lexington, KY (US); James H. Johnson, JR., Lexington, KY (US)

Correspondence Address: KING & SCHICKLI, PLLC, 247 NORTH BROADWAY, LEXINGTON, KY, 40507, US

(21) Appl. No.: 12/860,556

(22) Filed: Aug. 20, 2010

Related U.S. Application Data
(60) Provisional application No. 61/235,857, filed on Aug. 21, 2009.

(51) Int. Cl. G08B 29/00; G06F 17/00

(52) U.S. Cl. 340/5.83; 235/375; 340/5.82

(57) ABSTRACT

The present invention relates to a system for completing a secure transaction. The system includes a one-of-a-kind personal identification code and an object code identifying an object to be the subject of the secure transaction. In addition, the system includes a proof reading apparatus used to determine an individual seeking to complete the secure transaction is the one authorized to complete the secure transaction.

### This application claims priority to U.S. Provisional Patent Application Ser. No. 61/235,857 filed 21 Aug. 2009, the entire disclosure of which is incorporated herein by reference.

### TECHNICAL FIELD AND INDUSTRIAL APPLICABILITY OF THE INVENTION

The present invention relates generally to the field of secure transactions, and more particularly, to a system and method for completing secure transactions.

### BACKGROUND OF THE INVENTION

Security systems for screening personnel, on-site security and for completing secure transactions are known in the art. Examples of such systems are disclosed in, for example, U.S. Pat. No. 7,515,055 to Sweatte, U.S. Pat. No. 7,752,466 to Ginter et al and U.S. Pat. No. 7,605,709 to Tolliver. The present invention relates to a system and method for completing secure transactions that are particularly useful to ensure that prescription drugs and narcotics are only purchased by and distributed to the patient to whom the drugs and narcotics have been prescribed.

### SUMMARY OF THE INVENTION

In accordance with the purposes of the present invention as described herein, a system is provided for completing a secure transaction. The system comprises a one of a kind personal identification code, an object code identifying an object to be the subject of the secure transaction and a proof reading apparatus used to determine an individual seeking to complete the secure transaction is the one authorized to complete the secure transaction.

In accordance with yet another aspect of the present invention a method is provided for completing a secure transaction. The method comprises the steps of assigning a one of a kind personal identification code to a person, assigning an object code to an object to be the subject of the secure transaction, requiring presentation of both the personal identification code and the object code by the person seeking to complete the secure transaction and requiring proof from the person to show the person is the one assigned to the one of a kind personal identification code before completing the secure transaction. The personal identification code is based upon a unique physical characteristic or biometric-identifier of a person.

In the following description there is shown and described several different embodiments of the invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIG. 1 is a schematical block diagram of the method of the present invention;

FIG. 2 is a schematical representation of the proof reading apparatus of the present invention for completing a secure transaction; and

FIG. 3 is a schematical representation of the complete system of the present invention for completing a secure transaction.

Reference will now be made in detail to the present preferred embodiment of the invention, examples of which are illustrated in the accompanying drawings.

### DETAILED DESCRIPTION OF THE PREFERRED EMBODIMENTS OF THE INVENTION

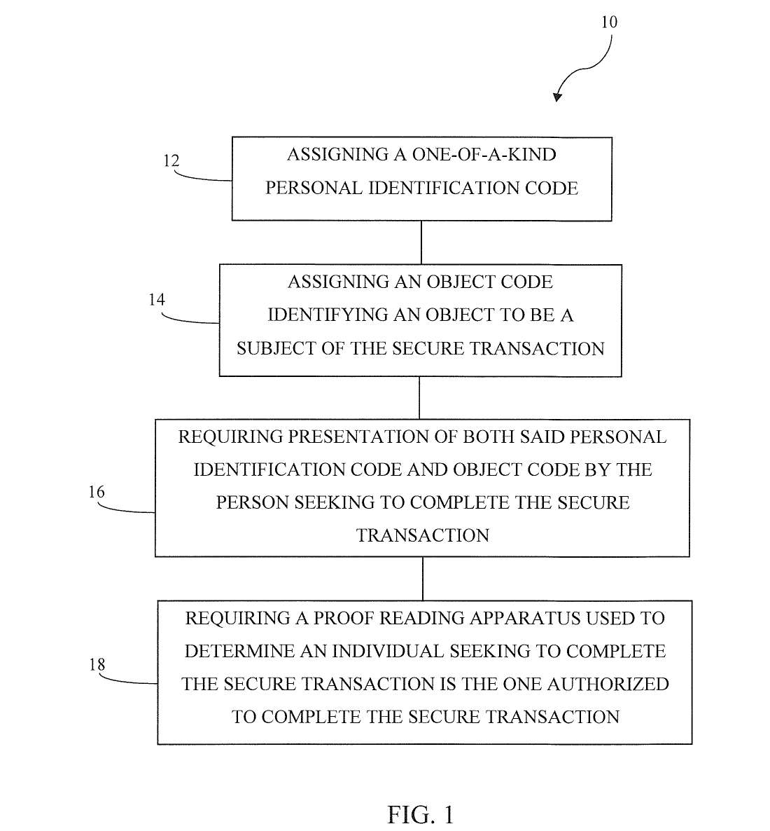

As illustrated in FIG. 1, the method (10) of the present invention for completing a secure transaction comprises assigning a person a unique, one-of-a-kind personal identification code based upon a unique, one-of-a-kind physical characteristic or biometric identifier of that person (12). Such a personal identification code may, for example, be DNA based, fingerprint based, thumb print based, retina based or iris based. The method (10) also includes assigning an identifying bar code to an object to be the subject of the secure transaction (14).

In order to complete the transaction and secure the object, the combined personal identification code and the identifying bar code must be presented together by the person (16). The person must also provide proof he is the person to which the unique, one-of-a-kind personal identification code has been assigned (18). This may be done by providing a specimen for DNA testing, a fingerprint, a thumb print, a retina scan, an iris scan or the like. Should the proof provided by the person match the one-of-a-kind personal identification code, the transaction is completed by providing the object to the individual. Such a method, may, for example, be utilized to ensure that prescription drugs and narcotics are distributed only to the person to whom they are to be provided. Similarly, this system may be utilized to transfer highly sensitive information such as personal medical records and financial records.

A proof reading apparatus (50) is part of the method (see FIG. 2). The proof reading apparatus (50) allows the operator to read the “proof” provided by the person seeking to complete the transaction in order to ensure that person is the one and only individual authorized to complete that transaction. The proof reader may comprise a DNA scanner or specimen reader, a fingerprint reader, a thumb print reader, a retina scanner, an iris scanner or the like. The DNA specimen reader is capable of reading any appropriate DNA specimen such as a saliva specimen, a blood specimen or a tissue cell specimen. In one particularly useful embodiment the proof reader (50) is provided as part of a cell phone, mobile phone, music player or other hand-held electronic device (60).

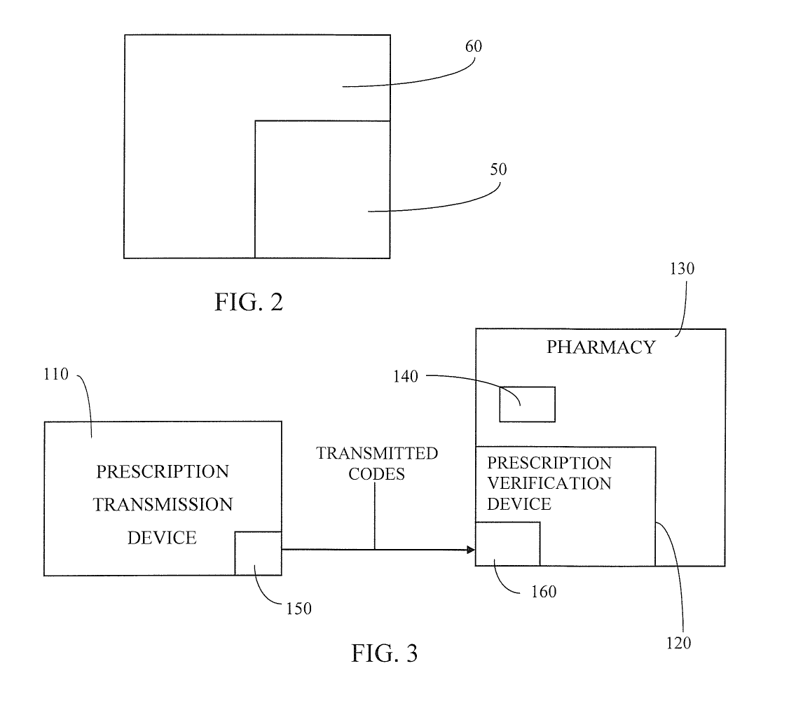

A secure transaction communication system (100) for narcotics comprises a prescription transmission device (110) for use by a prescribing physician (may be mobile or office based) and a patient and prescription verification device (120) for use by a pharmacy (130) dispensing the narcotics (140) (see FIG. 3). The prescription transmission device (110) includes a one-of-a-kind personal identification code and a narcotic identification code generator and transmitter (150). In contrast, the prescription verification device (120) includes a one-of-a-kind personal identification code and a narcotic identification code receiver.

Such a device (150) transmits both codes to a selected pharmacy (130). When an individual arrives at the pharmacy seeking the narcotics, the pharmacist verifies the identity of the individual. More specifically, the pharmacist determines the individual's one-of-a-kind personal identification code and compares it to the code previously transmitted by the physician. If it matches, the pharmacist then fills the prescription for the narcotic identified by the narcotic identification code also previously transmitted by the physician.

The foregoing description of the preferred embodiments of the present invention have been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. A system for completing a secure transaction, comprising:
a one-of-a-kind personal identification code;
an object code identifying an object to be a subject of the secure transaction; and
a proof reading apparatus used to determine an individual seeking to complete the secure transaction is the one authorized to complete the secure transaction.

2. The system of claim 1, wherein said one-of-a-kind personal identification code is DNA based.

3. The system of claim 1, wherein said one-of-a-kind personal identification code is fingerprint based.

4. The system of claim 1, wherein said one-of-a-kind personal identification code is thumbprint based.

5. The system of claim 1, wherein said one-of-a-kind personal identification code is retina based.

6. The system of claim 1, wherein said one-of-a-kind personal identification code is iris based.

7. The system of claim 1, wherein said one-of-a-kind personal identification code is biometric identifier based.

8. The system of claim 7 wherein said object code is a bar code.

9. The system of claim 8 wherein said proof reading apparatus is a DNA specimen reader.

10. The system of claim 8 wherein said proof reading apparatus is a fingerprint or thumbprint reader.

11. The system of claim 8 wherein said proof reading apparatus is provided as part of a cell phone.

12. The system of claim 8 wherein said proof reading apparatus is provided as part of a mobile phone.

13. The system of claim 8 wherein said proof reading apparatus is provided as part of a music player.

14. The system of claim 8 wherein said proof reading apparatus is provided as part of a hand-held electronic device.

15. A method for completing a secure transaction, comprising:
assigning a one-of-a-kind personal identification code to a person, said personal, identification code being based upon a unique physical characteristic or biometric identifier of a person;
assigning an object code to an object to be a subject of the secure transaction;
requiring presentation of both said personal identification code and object code by the person seeking to complete the secure transaction; and
requiring proof from the person to show the person is the one assigned to the one-of-a-kind personal identification code before completing the secure transaction.

16. The method of claim 15 further including using a proof reading apparatus to determine if a specimen provided by the person seeking to complete the secure transaction belongs to the person assigned the one-of-a-kind personal identification code.

17. The method of claim 16, providing said proof reading apparatus as part of a cell phone.

18. The method of claim 16, providing said proof reading apparatus as part of a mobile phone.

19. The method of claim 16, providing said proof reading apparatus as part of a music player.

20. The method of claim 16, providing said proof reading apparatus as part of a hand-held electronic device.
